(19) United States
(12) Patent Application Publication
(10) Pub. No.: US 2016/0238865 A1
(43) Pub. Date: Aug. 18, 2016

(54) DISPLAY PANEL AND METHOD OF MANUFACTURING THE DISPLAY PANEL

(71) Applicant: Samsung Display Co., Ltd., Yongin-si (KR)

(72) Inventors: Seung-Yeon CHAE, Hwaseong-si (KR); Hyoung Sub LEE, Yongin-si (KR); Tae Woon CHA, Seoul (KR)

(21) Appl. No.: 14/811,517

(22) Filed: Jul. 28, 2015

(30) Foreign Application Priority Data
Feb. 17, 2015 (KR) 10-2015-0024469

(51) Int. Cl. G02F 1/1339; G02F 1/1333; G02F 1/1335

(52) U.S. Cl. CPC G02F 1/1339; G02F 1/133514; G02F 1/133345

(57) ABSTRACT

Disclosed are a display panel and a method of manufacturing a display panel. The display panel according to an exemplary embodiment of the present invention includes a lower substrate; an upper substrate facing the lower substrate; a sealing member interposed between the lower substrate and the upper substrate and configured to bond the lower substrate and the upper substrate; and a short pattern formed outside the sealing member from the sides of the lower substrate and the upper substrate, in which the short pattern is formed to be spaced apart at a predetermined interval or formed over the entire peripheries of the lower substrate and the upper substrate.

### CLAIM OF PRIORITY

This application claims the priority to and all the benefits accruing under 35 USC §119 of Korean Patent Application No. 10-2015-0024469 filed in the Korean Intellectual Property Office (KIPO) on Feb. 17, 2015, the entire contents of which are incorporated herein by reference.

### BACKGROUND OF THE INVENTION

1. Field of disclosure

The present invention relates to a display panel and a method of manufacturing a display panel, and more particularly, to a display panel capable of implementing a large screen by reducing a size of a bezel, and a method of manufacturing a display panel.

2. Description of the Related Art

A computer monitor, a television, a mobile phone, and the like, which are widely used today, require a display device. Examples of the display device include a cathode ray tube display device, a liquid crystal display, a plasma display device, and the like.

The liquid crystal display, which is one of the most common types of flat panel displays currently in use, includes a display panel having two substrates with field generating electrodes, such as a pixel electrode and a common electrode formed thereon, and a liquid crystal layer is disposed between the field generating electrodes. An electric field is generated in the liquid crystal layer by applying a voltage to the field generating electrodes, and the direction of liquid crystal molecules of the liquid crystal layer is determined by the generated electric field, thereby controlling polarization of incident light so as to display images.

A display panel of the liquid crystal display includes a display area having pixels formed thereon to display an image, and a non-display area excluding the display area. The non-display area is a region required for driving the liquid crystal display, in which a screen is not displayed because a gate driver, a data driver, and the like are attached to the non-display area. Such a non-display area is referred to as a bezel.

In recent years, as a size of the liquid crystal display is increased, the display area needs to be maximized, and the non-display area increased in size for the maximized display area needs to be minimized. To this end, it is important to design the bezel, which is the non-display area, to have a small width.

To bond two substrates of a display panel of the liquid crystal display at the bezel of the liquid crystal display, a sealant is applied between the two substrates of the display panel and a short pattern is formed on a common electrode for electrically connecting the two substrates of the display panel.

However, there are many problems in reducing the width of the sealant used to bond the two substrates of the display panel due to a limitation of manufacturing process.

According to the related art, the two substrates of the display panel are bonded after the short pattern is formed to have a form of dots between the two substrates of the display panel, and in this case, there is a problem in that the distance between the two substrates of the display panel is increased due to non-uniform thickness of the dots. Further, the field generating electrodes could be short-circuited through the excess short pattern flown into the region between the field generating electrodes during manufacturing process, through external impact, or after prolonged use, which may cause a problem of driving the display panel.

Therefore, researches are required to minimize the size of the bezel by minimizing the width of the short pattern and uniformly maintain the distance between the two substrates of the display panel.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a display panel and a method of manufacturing a display panel having advantages of minimizing a size of a bezel, which is a non-display area of a display device.

An exemplary embodiment of the present invention provides a display panel including a lower substrate; an upper substrate facing the lower substrate; a sealing member interposed between the lower substrate and the upper substrate and configured to bond the lower substrate and the upper substrate; and a short pattern formed outside the sealing member from the sides of the lower substrate and the upper substrate, in which the short pattern is formed to be spaced apart at a predetermined interval or formed over the entire peripheries of the lower substrate and the upper substrate.

The short pattern may include a conductive polymer material.

The short pattern may be PEDOT/PSS.

The display panel may further include an insulating layer coated on the outside of the lower substrate, the upper substrate, and the short pattern.

The insulating layer may include a colored polymer material.

The short pattern may be formed by a side printer at the sides of the lower substrate, the upper substrate, and the sealing member.

The insulating layer may be formed by a side printer at the sides of the lower substrate, the upper substrate, and the short pattern.

The lower substrate may include a thin film transistor substrate.

The upper substrate may include a color filter.

Another exemplary embodiment of the present invention provides a method of manufacturing a display panel including bonding a lower substrate and an upper substrate by a sealing member; forming a short pattern at peripheries of the lower substrate and the upper substrate from the sides of the lower substrate, the upper substrate, and the sealing member; and forming an insulating layer on the sides of the lower substrate, the upper substrate, and the sealing member.

The method may further include, after polishing the short pattern, polishing a protruding portion of the short pattern.

The method may further include, after the forming of the insulating layer, polishing a protruding portion of the insulating layer formed on the peripheries of the lower substrate and the upper substrate.

The short pattern may include a conductive polymer material.

The short pattern may include PEDOT/PSS.

The insulating layer may include a colored polymer material.

The short pattern and the insulating layer may be formed by a side printer.

By a display panel and a method of manufacturing a display panel according to an exemplary embodiment of the present invention, it is possible to minimize a width of a short pattern and uniformly maintain distance between a lower substrate and an upper substrate by forming a short pattern from the sides of the lower substrate and the upper substrate while uniformly maintaining a distance between the lower substrate and the upper substrate.

Further, an insulating layer is formed by injecting a colored polymer material at the sides of the lower substrate and the upper substrate, thereby minimizing a width of an insulating layer and preventing light leaking from a liquid crystal from being scattered.

The widths of the short pattern and the insulating layer are minimized to minimize a width of a bezel, which is a non-display area, such that a large screen of a display device may be implemented.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein

FIG. 1 is a perspective view illustrating a configuration of a display panel according to an exemplary embodiment of the present invention.

FIG. 2 is a partial cross-sectional view taken along line X-X1 of FIG. 1.

FIGS. 3A to 3E are processes illustrating a method of manufacturing a display panel according to an exemplary embodiment of the present invention.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification

In addition, the size and thickness of each configuration shown in the drawings are arbitrarily shown for understanding and ease of description, but the present invention is not limited thereto. In the drawings, the thickness of layers, films, panels, regions, etc., are exaggerated for clarity.

It will be understood that when an element such as a layer, film, region, or substrate is referred to as being “on” another element, it can be directly on the other element or intervening elements may also be present.

Hereinafter, a display panel according to an exemplary embodiment of the present invention will be described in detail with reference to the accompanying drawings.

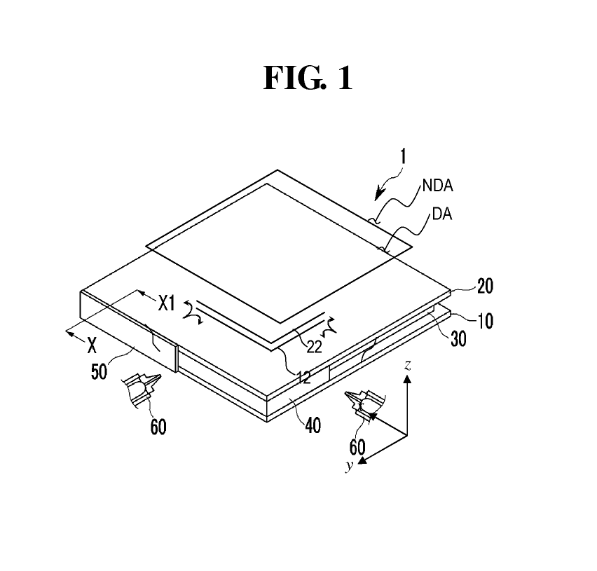

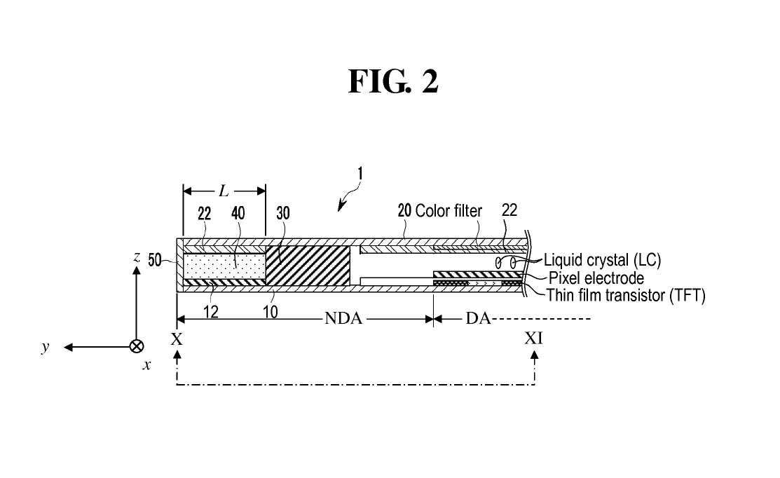

FIG. 1 is a perspective view illustrating a configuration of a display panel according to an exemplary embodiment of the present invention. FIG. 2 is a partial cross-sectional view taken along line X-X1 of FIG. 1.

A structure of a liquid crystal panel according to an exemplary embodiment of the present invention will be described with reference to FIGS. 1 and 2. Even though the exemplary embodiment of the present invention illustrates the liquid crystal panel, the scope of the present invention is not necessarily limited thereto, and the present invention may also be applied to a display panel used for other display devices, such as an organic light emitting panel.

As illustrated in FIGS. 1 and 2, a display panel according to an exemplary embodiment of the present invention includes a lower substrate 10, an upper substrate 20 facing the lower substrate 10, a sealing member 30 interposed between the lower substrate 10 and the upper substrate 20 to bond the lower substrate 10 and the upper substrate 20, and a liquid crystal (LC) provided between the upper substrate 20 and the lower substrate 10.

Meanwhile, the liquid crystal panel is divided into an active area and a black matrix, and according to the exemplary embodiment of the present invention, the active area corresponds to a display area, and the black matrix is a non-display area NDA and corresponds to a region where wirings for driving the liquid crystal panel are installed.

According to the exemplary embodiment of the present invention, the lower substrate 10 is formed as a thin film transistor substrate, and the upper substrate 20 is formed as a color filter substrate. However, a position of a transistor and a position of a color filter are not limited thereto.

A thin film transistor is formed in the lower substrate 10, and in the lower substrate 10, a gate electrode, a gate insulating layer, a semiconductor layer, and an ohmic contact layer are sequentially formed. Further, a drain electrode and a source electrode are formed on the ohmic contact layer and the gate insulating layer, and a passivation layer is formed on the drain electrode and the source electrode. The thin film transistor is formed in the active area corresponding to an internal region of the sealing member 30. In addition, a lower common electrode 12 for electric connection with the upper substrate 20 is formed on a part of the lower substrate 10.

Meanwhile, a color filter 21 and an upper common electrode 22 are sequentially formed in the active area of the upper substrate 20. The upper common electrode 22 may be formed of a transparent electrode made of indium tin oxide (ITO), indium zinc oxide (IZO), and the like. The upper common electrode 22 is electrically connected to the lower common electrode 12 through a short pattern 40.

The configuration of the thin film transistor, the common electrode, and the like is illustrative, the present invention is not limited thereto, and the configuration thereof may be modified in various ways.

The lower substrate 10 and the upper substrate 20 are bonded by the sealing member 30. The sealing member 30 is formed on the black matrix 24 while being spaced apart from the active area so as to surround the active area. The forming of the sealing member 30 while being spaced apart from the active area is to prevent a sealant from being introduced into the active area during a process of curing the sealant after applying the sealant.

The sealing member 30 serves to preserve a liquid crystal LC between both substrates in addition to serving to bond the lower substrate 10 and the upper substrate 20.

The short pattern 40 is provided outside the sealing member 30 and along the peripheries of the lower substrate 10 and the upper substrate 20. The short pattern 40 serves to electrically connect the lower substrate 10 and the upper substrate 20. To this end, the short pattern 40 includes a conductive polymer material. Examples of the short pattern 40 include poly(3,4-ethylenedioxythiophene)/poly(4-styrenesulfonate) (PEDOT/PSS).

The short pattern 40 is formed by a side printer 60. The side printer 60 injects a conductive polymer material toward the outside of the sealing member 30 at the sides of the lower substrate 10 and the upper substrate 20 to fill a space between the lower substrate 10 and the upper substrate 20. The short pattern 40 may be formed at the peripheries of the lower substrate 10 and the upper substrate 20 to be spaced apart at a predetermined interval, or formed in a line form over the entire peripheries of the lower substrate 10 and the upper substrate 20.

As described above, the short pattern 40 having width L is formed from the sides of the lower substrate 10 and the upper substrate 20 while maintaining a predetermined interval between the lower substrate 10 and the upper substrate 20, thereby minimizing the width of a bezel which is a non-display area NDA of the liquid crystal panel. Further, it is possible to uniformly maintain a distance between the lower substrate 10 and the upper substrate 20.

The outside of the lower substrate 10, the upper substrate 20, and the short pattern 40 are coated with an insulating layer 50. The insulating layer 50 serves to electrically insulate the lower substrate 10, the upper substrate 20, and the short pattern 40 and a chassis (not shown) mounted with the liquid crystal panel. The chassis is formed below the display panel 1 and includes a bottom and a curved side which extends from one edge of the bottom. The curved side of the chassis may be formed to the vertical from the bottom to store and protect the display panel 1 and back light assembly (not shown). Further, the insulating layer 50 serves to prevent light leaked from the liquid crystal layer provided between the lower substrate 10 and the upper substrate 20 from being reflected from the chassis and leaking to the outside. To this end, the insulating layer 50 includes a colored polymer material. The colored polymer material has impact resistance and a high adhesive property. The colored polymer material may be an organic insulating material, and may be colored to reduce the reflectivity.

The insulating layer 50 is formed by the side printer 60. The side printer 60 injects the colored polymer material at the sides of the lower substrate 10, the upper substrate 20, and the short pattern 40 to form the insulating layer 50 at the sides of the lower substrate 10, the upper substrate 20, and the short pattern 40.

Hereinafter, a method of manufacturing a display panel according to an exemplary embodiment of the present invention will be described in detail with reference to the accompanying drawings.

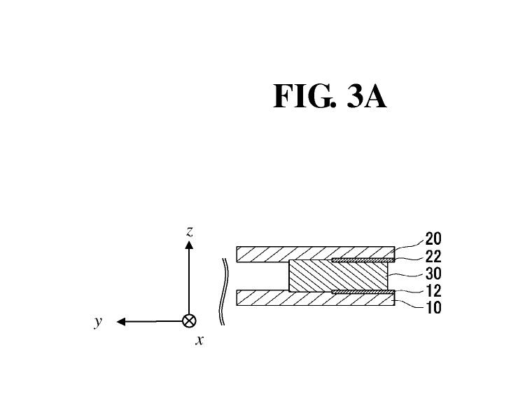

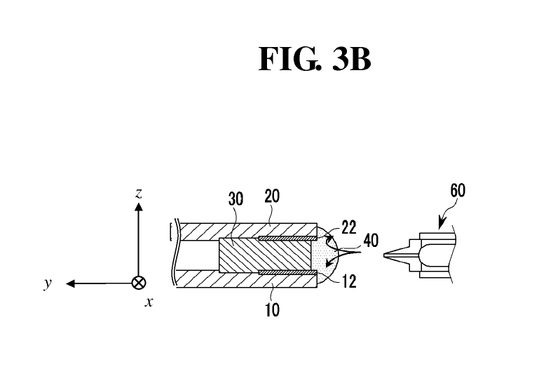

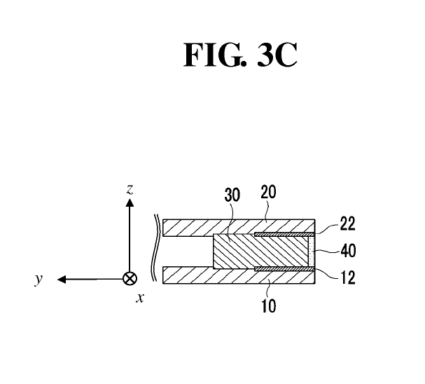

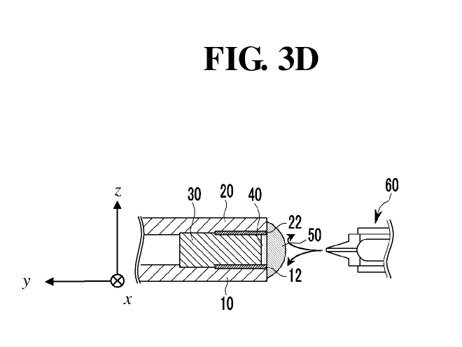

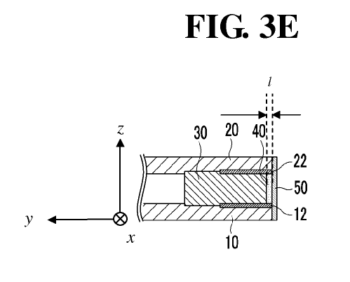

FIGS. 3A to 3E are processes illustrating a method of manufacturing a display panel according to an exemplary embodiment of the present invention. FIGS. 3A to 3E illustrate only essential constituent elements for understanding and ease of description.

First, as illustrated in FIG. 3A, a sealant is applied to form the sealing member 30 at the periphery of the lower substrate 10. In this case, the sealant is applied while being spaced apart from the active area by a predetermined distance. A liquid crystal LC is dropped into the active area positioned inside the sealant, and the upper substrate 20 and the lower substrate 10 are bonded.

As illustrated in FIG. 3B, the short pattern 40 is formed along the peripheries of the lower substrate 10 and the upper substrate 20 from the sides of the lower substrate 10, the upper substrate 20, and the sealing member 30. The short pattern 40 serves to electrically connect the lower substrate 10 and the upper substrate 20. The short pattern 40 is formed by injecting, by the side printer 60, the conductive polymer material (for example, PEDOT/PSS) to the sides of the lower substrate 10, the upper substrate 20, and the sealing member 30.

As illustrated in FIG. 3C, when the conductive polymer material is injected through the side printer 60, the conductive polymer material protrudes outward from the sides of the lower substrate 10, the upper substrate 20, and the sealing member 30. Therefore, the width/of the short pattern 40 is minimized by a process of polishing a protruding portion of the conductive polymer material. Curing the short pattern 40 step by heating or UV irradiation, etc may be further included before the polishing step.

As described above, the short pattern 40 is formed by injecting the conductive polymer material at the sides of the lower substrate 10 and the upper substrate 20 through the side printer 60, thereby minimizing the width/of the short pattern 40. Further, the short pattern 40 is formed on the outer sides of the lower substrate 10 and the upper substrate 20, thereby uniformly maintaining the distance of the lower substrate 10 and the upper substrate 20.

As illustrated in FIG. 3D, an insulating layer 50 is formed at the sides of the lower substrate 10 and the upper substrate 20 by injecting an insulator through the side printer 60 at the sides of the lower substrate 10 and the upper substrate 20 on which the short pattern 40 is formed. The insulator may be a colored polymer material.

As described above, the insulator is coated on the sides of the lower substrate 10 and the upper substrate 20, thereby preventing the lower substrate 10 and the upper substrate 20 and the chassis mounted with the liquid crystal panel from being electrically short-circuited. In addition, the colored polymer material is used as the insulator, thereby preventing light leaking from the liquid crystal provided between the lower substrate 10 and the upper substrate 20 from being scattered.

As illustrated in FIG. 3E, when the colored polymer material is injected through the side printer 60, the colored polymer material protrudes outward from the sides of the lower substrate 10 and the upper substrate 20. Therefore, by polishing the protruding portion of the colored polymer material, it is possible to minimize the thickness of the insulating layer 50 by the process of polishing the injected colored polymer material, thereby minimizing the thickness of the bezel, which is a non-display area NDA of the liquid crystal panel. Curing the colored polymer material step by heating or UV irradiation, etc may be further included before the polishing step.

From the foregoing, while this invention has been described in connection with what is presently considered to be practical exemplary embodiments, it is to be understood that the invention is not limited to the disclosed embodiments and modified embodiments. For example, the liquid crystal panel has been described as an example of the present invention, but the present invention may also be applied to display panels of other display devices such as an organic light emitting device. As described above, the scope of the present invention is defined by the scope of the claims to be described below, and it will be easily appreciated by those skilled in the art that various changes and modifications may be made without departing from the spirit and scope of the claims.

### DESCRIPTION OF SYMBOLS

10: Lower substrate

12: Lower common electrode

20: Upper substrate

22: Upper common electrode

24: Black matrix

30: Sealing member

40: Short pattern

50: Insulating layer

60: Side printer.

What is claimed is:

1. A display panel comprising:
a lower substrate;
an upper substrate facing the lower substrate;
a sealing member interposed between the lower substrate and the upper substrate and configured to bond the lower substrate and the upper substrate; and
a short pattern formed at an outer side of the sealing member at outer sides of the lower substrate and the upper substrate,
wherein the short pattern is formed to be one of a pattern having portions spaced apart from each other by a predetermined interval and a continuous pattern formed over entire peripheries of the lower substrate and the upper substrate.

2. The display panel of claim 1, wherein the short pattern includes a conductive polymer material.

3. The display panel of claim 2, wherein the short pattern is PEDOT/PSS.

4. The display panel of claim 1, further comprising an insulating layer coated on an outer side of the lower substrate, an outer side of the upper substrate, and an outer side of the short pattern.

5. The display panel of claim 4, wherein the insulating layer includes a colored polymer material.

6. The display panel of claim 1, wherein the short pattern is formed by a side printer at the sides of the lower substrate, the upper substrate, and the sealing member.

7. The display panel of claim 4, wherein the insulating layer is formed by a side printer at the sides of the lower substrate, the upper substrate, and the short pattern.

8. The display panel of claim 1, wherein the lower substrate includes a thin film transistor substrate.

9. The display panel of claim 1, wherein the upper substrate includes a color filter.

10. A method of manufacturing a display panel comprising:
bonding a lower substrate and an upper substrate by a sealing member;
forming a short pattern at peripheries of the lower substrate and the upper substrate from the sides of the lower substrate, the upper substrate, and the sealing member; and
forming an insulating layer on the sides of the lower substrate, the upper substrate, and the sealing member.

11. The method of claim 10, further comprising after forming the short pattern, polishing a protruding portion of the short pattern.

12. The method of claim 11, further comprising after the forming of the insulating layer, polishing a protruding portion of the insulating layer.

13. The method of claim 10, wherein the short pattern includes a conductive polymer material.

14. The method of claim 13, wherein the short pattern includes PEDOT/PSS.

15. The method of claim 10, wherein the insulating layer includes a colored polymer material.

16. The method of claim 10, wherein the short pattern and the insulating layer are formed by a side printer.
